(19) United States
(12) Patent Application Publication
(10) Pub. No.: US 2026/0092852 A1
(43) Pub. Date: Apr. 2, 2026

(54) METHOD AND APPARATUS FOR MONITORING POLYURETHANE DIFFUSION IN A POROUS MEDIUM, DEVICE, AND MEDIUM

(71) Applicant: Sun Yat-sen University, Guangzhou (CN)

(72) Inventors: Dingfeng CAO, Guangzhou (CN); Jiajia ZHENG, Guangzhou (CN); Chengchao GUO, Guangzhou (CN); Fuming WANG, Guangzhou (CN); Fan YANG, Guangzhou (CN); Lei QIN, Guangzhou (CN); Zhichuang SHI, Guangzhou (CN); Feifan SHI, Guangzhou (CN)

(21) Appl. No.: 18/999,102

(22) Filed: Feb. 18, 2025

(30) Foreign Application Priority Data
Sep. 27, 2024 (CN) 202411360769.4

(51) Int. Cl. G01N 13/00

(52) U.S. Cl. CPC G01N 13/00; G01N 2013/003

(57) ABSTRACT

Provided are a monitoring method and apparatus, a device, and a medium. The method includes selecting a diffusion model according to a diffusion characteristic of polyurethane in the porous medium and winding a distributed optical fiber around at least one sensing cage to form a helical structure; mapping coordinates of each temperature measurement point on the helical structure to a spatial Cartesian coordinate system of the porous medium; measuring an initial moisture field of the porous medium before polyurethane infiltration; monitoring a post-infiltration moisture field in the stabilized state of temperature transmission fluctuations during the polyurethane diffusion that occurs in the polyurethane infiltration in the porous medium; and analyzing a change in water content based on the initial moisture field and the post-infiltration moisture field and identifying a polyurethane diffusion distribution field in the porous medium in conjunction with the diffusion model.

### CROSS-REFERENCE TO RELATED APPLICATION

This application claims priority to Chinese Patent Application No. 202411360769.4, filed on Sep. 27, 2024, the disclosure of which is incorporated herein by reference in its entirety.

### TECHNICAL FIELD

The present application relates to the field of porous medium monitoring technology, particularly a method and apparatus for monitoring polyurethane diffusion in a porous medium, a device, and a medium.

### BACKGROUND

Chemical grouting has long been regarded as the most effective method of preventing water influx in underground engineering. Polyurethane, as a fast-setting grout, significantly enhances the engineering properties of geotechnical material due to its characteristics of strong permeability and low expansion when cement-based or other particulate materials cannot achieve the desired effect. However, as grouting is underground concealed engineering, grouting control techniques in the related art primarily rely on controlling the grout volume or pressure. In practice, these methods make it difficult to directly acquire the diffusion of grout in a porous medium. Currently, most underground concealed engineering monitoring techniques rely on point-based monitoring, not only costly but also prone to missed detection in actual engineering applications, making it difficult to achieve comprehensive monitoring of the grout diffusion process. Therefore, traditional underground engineering monitoring techniques cannot intuitively and extensively capture the diffusion of polyurethane in geotechnical material. There is an urgent need to develop new monitoring techniques to improve monitoring accuracy and coverage.

To overcome the limitations of the technologies in the related art, Distributed Temperature Sensing (DTS) systems, with their advantages of long range, low maintenance costs, and high precision, have been applied in the monitoring of calcium-rich sand moisture fields. For example, by utilizing heatable sensor cables (AHFO), a moisture inversion function is established based on the difference in the rate at which heat diffuses to the surroundings under varying moisture contents and infiltration speeds, enabling the monitoring of geotechnical moisture distribution. During the grouting process, polyurethane grout not only displaces water in the porous medium but also chemically reacts with water. In this process, the thermal conductivity of the grout during the phase transition process is different from the thermal conductivity of the grout after curing. This phenomenon leads to changes in the heat transfer properties of the cured porous medium. Therefore, the application of distributed optical fiber temperature sensing technology to monitoring of the diffusion of polyurethane in a porous medium is a pressing issue that needs to be addressed.

### SUMMARY

An object of the present application is to provide a method and apparatus for monitoring polyurethane diffusion in a porous medium, a device, and a medium to achieve precise monitoring the polyurethane diffusion range by using the distributed optical fiber monitoring technology in conjunction with the thermal conductivity change characteristics of the porous medium after polyurethane curing due to water reaction.

To solve this problem, the present application provides a method and apparatus for monitoring polyurethane diffusion in a porous medium, a device, and a medium.

In a first aspect, the present application provides a method for monitoring polyurethane diffusion in a porous medium. The method includes selecting a diffusion model according to a diffusion characteristic of polyurethane in the porous medium and winding a distributed optical fiber around at least one sensing cage according to a predetermined helical parameter to form a helical structure; establishing a spatial Cartesian coordinate system for the porous medium with a polyurethane infiltration point as an origin and mapping coordinates of each temperature measurement point on the helical structure to the spatial Cartesian coordinate system of the porous medium; connecting the optical fiber to a distributed temperature sensing system, calibrating an initial value of the distributed temperature sensing system, and measuring an initial moisture field of the porous medium before polyurethane infiltration; during the polyurethane diffusion that occurs in the polyurethane infiltration in the porous medium, monitoring temperature transmission fluctuations along the optical fiber by using the distributed temperature sensing system and acquiring a post-infiltration moisture field in a stabilized state of the temperature transmission fluctuations; and analyzing a change in water content based on the initial moisture field and the post-infiltration moisture field and identifying a polyurethane diffusion distribution field in the porous medium in conjunction with the diffusion model.

In a second aspect, the present application provides an apparatus for monitoring polyurethane diffusion in a porous medium. The apparatus includes an apparatus establishment module, a coordinate mapping module, an initial measurement module, a diffusion monitoring module, and a diffusion identification module.

The apparatus establishment module is configured to select a diffusion model according to a diffusion characteristic of polyurethane in the porous medium and wind a distributed optical fiber around at least one sensing cage according to a predetermined helical parameter to form a helical structure.

The coordinate mapping module is configured to establish a spatial Cartesian coordinate system for the porous medium with a polyurethane infiltration point as an origin and map coordinates of each temperature measurement point on the helical structure to the spatial Cartesian coordinate system of the porous medium.

The initial measurement module is configured to connect the optical fiber to a distributed temperature sensing system, calibrate an initial value of the distributed temperature sensing system, and measure an initial moisture field of the porous medium before polyurethane infiltration.

The diffusion monitoring module is configured to, during the polyurethane diffusion that occurs in the polyurethane infiltration in the porous medium, monitor temperature transmission fluctuations along the optical fiber by using the distributed temperature sensing system and acquire a post-infiltration moisture field in a stabilized state of the temperature transmission fluctuations.

The diffusion identification module is configured to analyze a change in water content based on the initial moisture field and the post-infiltration moisture field and identify a polyurethane diffusion distribution field in the porous medium in conjunction with the diffusion model.

In a third aspect, the present application also provides a computer device. The computer device includes a processor and a memory. The processor is connected to the memory. The memory is configured to store a computer program. The processor is configured to execute the computer program to cause the computer device to perform the steps of any preceding method.

In a fourth aspect, the present application also provides a computer-readable storage medium storing a computer program. When the computer program is executed, the steps of any preceding method are performed.

### BRIEF DESCRIPTION OF DRAWINGS

FIG. 1 is a flowchart of a method for monitoring polyurethane diffusion in a porous medium according to an embodiment of the present application.

FIG. 2 is a diagram illustrating the structure of a cylindrical sensing cage according to an embodiment of the present application.

FIG. 3 is an unfolded view of a helical structure according to an embodiment of the present application.

FIG. 4 is a diagram of the length of a partial helix that does not satisfy a single-turn requirement according to an embodiment of the present application.

FIG. 5 is a diagram of a distributed temperature sensing system for a polyurethane diffusion distribution field according to an embodiment of the present application.

FIG. 6 is a diagram of an apparatus for monitoring polyurethane diffusion in a porous medium according to an embodiment of the present application.

FIG. 7 is a diagram illustrating the structure of a computer device according to an embodiment of the present application.

### DETAILED DESCRIPTION

The following embodiments are described in conjunction with drawings to illustrate the present application and not to limit the present application. The drawings are for reference and illustration purposes and do not limit the patent protection scope of the present application as numerous modifications can be made to the present application without departing from the spirit and scope of the present application.

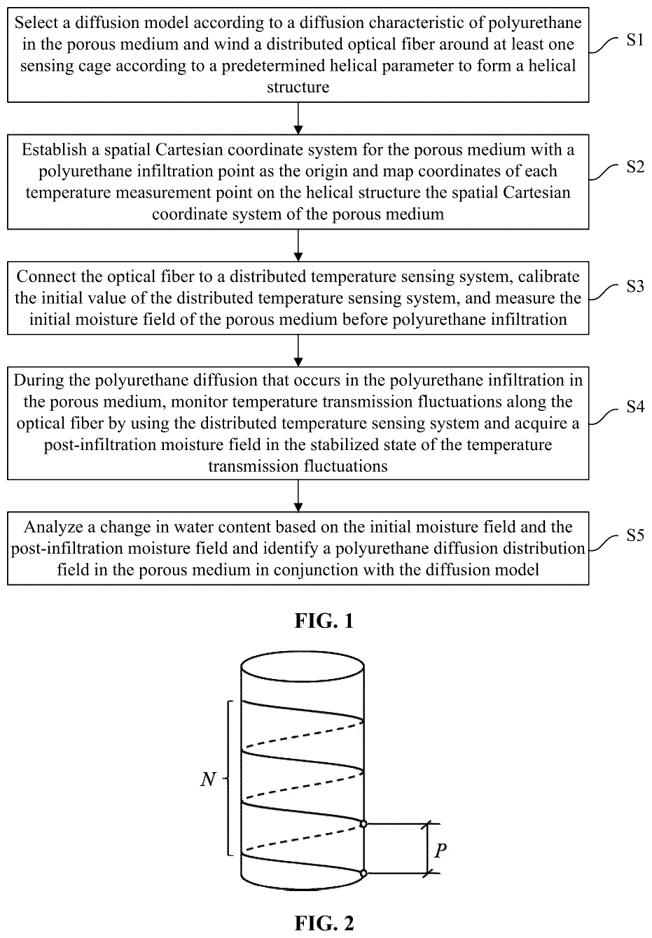

Referring to FIG. 1, an embodiment of the present application provides a method for monitoring polyurethane diffusion in a porous medium. As shown in FIG. 1, the method includes the following steps:

In S1, a diffusion model is selected according to a diffusion characteristic of polyurethane in the porous medium, and a distributed optical fiber is wound around at least one sensing cage according to a predetermined helical parameter to form a helical structure.

In S2, a spatial Cartesian coordinate system for the porous medium is established with a polyurethane infiltration point as the origin, and coordinates of each temperature measurement point on the helical structure are mapped to the spatial Cartesian coordinate system of the porous medium.

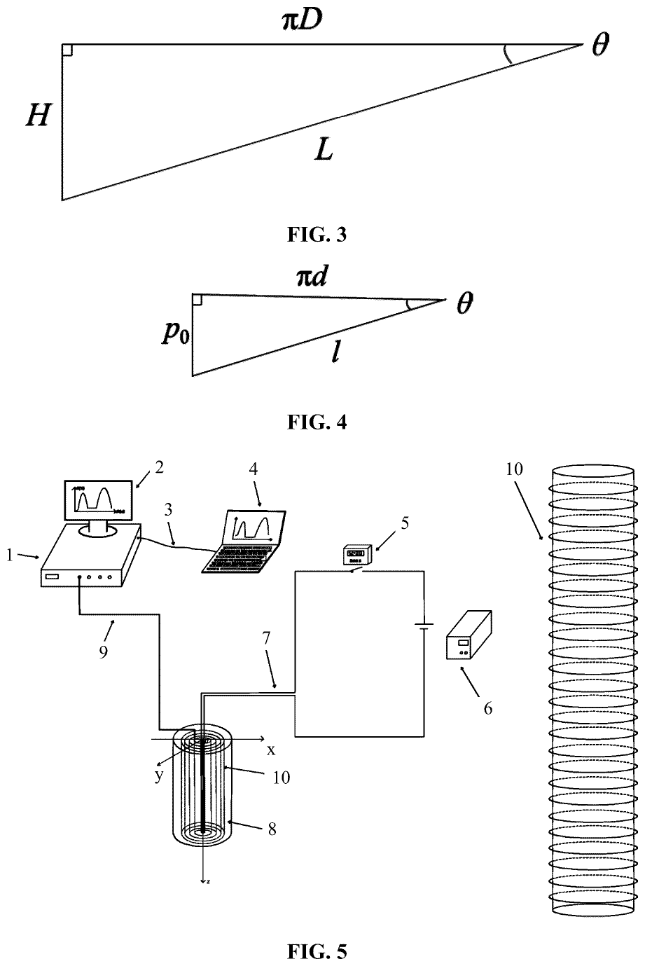

In the monitoring of grout diffusion in the process of grouting in the porous medium, in this embodiment, a diffusion model may be selected based on the diffusion characteristics of polyurethane in the porous medium. The diffusion model may be a spherical diffusion model or a cylindrical-hemispherical diffusion model. The diffusion mode may be determined according to the number of injection holes and the permeability of the foundation. To achieve polyurethane diffusion monitoring, in this embodiment, during the fiber installation stage, an epoxy resin material may be used to wrap the distributed optical fiber around the sensing cage, forming a helical structure on the sensing cage. For ease of explanation, as shown in FIG. 2, in this embodiment, a cylindrical structure is used for the sensing cage as an example for detailed description. At this point, the optical fiber wrapped around the sensing cage is equivalent to a helical line wrapped around the cylinder. Those skilled in the art can set the shape of the sensing cage according to implementation cases, not limited to the embodiment of the present application. In three-dimensional space, a helical line is a curve that rotates around a certain axis (for example, the axis of the cylinder) and extends along the axis. When the helical structure is unfolded onto a two-dimensional plane, as shown in FIGS. 3 and 4, the helical parameters of the distributed optical fiber wrapped around the sensing cage include the number of fiber turns on each sensing cage, the pitch, and the helical angle. Mathematical expressions of the number of fiber turns, the pitch, and the helical angle are as follows:

$$N = \frac{H}{P}$$

$$P = \frac{π DH}{\sqrt{( L + H ) ( L - H )}}$$

The relationship expression between the pitch P and the helical angle θ is as follows:

$$θ = arctan ( \frac{P}{π D} )$$

$$0 \leq θ < \frac{π}{2}$$

Here for each of the at least one sensing cage, N denotes the number of fiber winding turns, H denotes the height of the sensing cage, P denotes the pitch, D denotes the diameter of the sensing cage, l denotes the internal fiber winding length on the sensing cage, and θ denotes the helical angle.

In the actual deployment of the distributed optical fiber, the length l of the optical fiber wound around each sensor cage is fixed. In this embodiment, the pitch PP is determined based on the diameter and the height of the sensor cage. One end of the optical fiber is connected to the distributed temperature sensing system (DTS) via a jumper cable. The DTS system is capable of capturing and transmitting the changes in temperature at each measurement point along the optical fiber in real time to a terminal device. The position where the temperature change occurs corresponds to the point where the polyurethane has spread along the temperature-sensing optical fiber. This position marks the position where the polyurethane has diffused onto the optical fiber, thus enabling the monitoring of the diffusion range of polyurethane in the porous medium.

To precisely describe this diffusion process, in this embodiment, the polyurethane permeation point is set as the origin, and the direction perpendicular to the porous medium is taken as the z-axis. A three-dimensional Cartesian coordinate system for the porous medium space is established, and the coordinates of each temperature measurement point on the helical structure are mapped to this coordinate system. This ensures that the length l of each corresponding target position on the optical fiber corresponds one-to-one with the coordinates in the porous medium space. Based on the coordinate changes of the initial moisture field and the post-permeation moisture field after temperature stabilization in the porous medium space coordinate system, the polyurethane diffusion in the porous medium is quantified. In this embodiment, MATLAB software is used to process real-time data, enabling the visualization of this diffusion process. For example, by using the MATLAB software and the Kd-Tree nearest neighbor search algorithm, a given coordinate point is selected, and the nearest coordinate point on neighboring sensing cages are identified as a point along the grout diffusion path in a certain direction. The algorithm traverses all coordinate points on the sensing cages to ensure that every coordinate point is matched. Next, this embodiment performs three-dimensional interpolation of adjacent spatial coordinate points to determine the diffusion path of the grout in that direction. Finally, through visualization, the grout diffusion at any given moment is shown, and the grout diffusion distribution field is exported.

For the situation of optical fiber deployment, this embodiment discusses two cases: one sensing cage and multiple sensing cages.

One sensing cage: When there is only one sensing cage, in this embodiment, it may be determined that the temperature measurement point is located on the nth winding turn of the sensing cage according to the winding length l of the optical fiber inside each sensing cage, the diameter D of the sensing cage, the height H of the sensing cage, and the length l₁ of connection between the starting end and the distributed temperature sensing system. The calculation formula for the number n of winding turns of the temperature measurement point on the sensing cage is:

$$n \sqrt{{( π D )}^{2} + {P}^{2}} \leq L - {l}_{1} \leq ( n + 1 ) \sqrt{{( π D )}^{2} + {P}^{2}}$$

$$So$$

$${p}_{0} = \frac{P}{L} ⋆ ( L - {l}_{1} - n \sqrt{{( π D )}^{2} + {P}^{2}} )$$

$$d = \frac{D}{L} ⋆ ( L - {l}_{1} - n \sqrt{{( π D )}^{2} + {P}^{2}} )$$

From this, the coordinates of each temperature measurement point on the helical line are further derived. In this embodiment, the coordinates of each temperature measurement point on the helical structure mapped to the spatial Cartesian coordinate system of the porous medium are as follows:

$$\{ \begin{matrix}\begin{matrix}x = \frac{d}{2} ⋆ cos θ \\ y = \frac{d}{2} ⋆ sin θ\end{matrix} \\ z = n ⋆ P + {p}_{0}\end{matrix}$$

Here (x, y, z) denote the coordinates of the temperature measurement point on the helical structure mapped to the Cartesian coordinate system of the porous medium space, θ denotes the helical angle, l denotes the winding length of the optical fiber in each sensing cage, n denotes the number of a helical turn where a point is located on the helical structure, D denotes the diameter of the sensing cage, P denotes the pitch, l₁ denotes the optical fiber length between the starting end of the sensing cage and a demodulator, p₀ denotes the length of a part not exceeding the length of the pitch, and d denotes the diameter corresponding to a part not exceeding the length of a single turn of the helical line.

Overlapping of multiple sensing cages: When there are at least two sensing cages (m sensing cages with overlapping central axes), in this embodiment, it is determined that each temperature measurement point is located on the nth turn of the tth sensing cage according to the diameter Dᵢ, the height Hᵢ, the number nᵢ of winding turns on each sensing cage, the pitch pᵢ, the helical angle θᵢ, and the optical fiber length lᵢ between the sensing cages. The value range of i is l≤i≤m. The serial number of a winding turn where the temperature measurement point is located on the sensing cage is calculated using the following formula:

$${\sum }_{i = 1}^{m} ( {l}_{i} + {L}_{i} ) \leq L \leq {\sum }_{i = 1}^{m} ( {l}_{i} + {L}_{i} )$$

$$l = L - {\sum }_{i = 1}^{m} ( {l}_{i} + {L}_{i} )$$

$${n}_{i} \sqrt{{( π {D}_{i} )}^{2} + {P}_{i}^{2}} \leq l \leq ( {n}_{i} + 1 ) \sqrt{{( π {D}_{i} )}^{2} + {P}_{i}^{2}}$$

$$So$$

$${p}_{0}^{′} = \frac{{P}_{i}}{{L}_{i}} ⋆ ( {L}_{i} - {\sum }_{i = 1}^{m} ( {l}_{i} + {L}_{i} ) - {n}_{i} \sqrt{{( π {D}_{i} )}^{2} + {P}_{i}^{2}}$$

$${d}^{′} = \frac{{D}_{i}}{{L}_{i}} ⋆ ( {L}_{i} - {\sum }_{i = 1}^{m} ( {l}_{i} + {L}_{i} ) - {n}_{i} \sqrt{{( π {D}_{i} )}^{2} + {P}_{i}^{2}}$$

Thus, the coordinates of each temperature measurement point on the helical line are obtained. The coordinates of each temperature measurement point on the helical structure mapped to the spatial Cartesian coordinate system of the porous medium are:

$$\{ \begin{matrix}{\begin{matrix}x = \frac{{d}^{′}}{2} ⋆ cos {θ}_{i} \\ y = \frac{{d}^{′}}{2} ⋆ sin θ\end{matrix}}_{i} \\ z = {n}_{i} ⋆ {P}_{i} + {p}_{0}^{′}\end{matrix}$$

Here (x, y, z) denote the coordinates of each temperature measurement point on the helical structure mapped to the spatial Cartesian coordinate system of the porous medium, i denotes the ith sensing cage, l≤i≤m, m denotes the number of sensing cages, θᵢ denotes the helical angle of the helical structure on the ith sensing cage, Lᵢ denotes the internal fiber winding length on the ith sensing cage, nᵢ denotes the serial number of a helical turn where a temperature measurement point is located on the helical structure of the ith sensing cage, Di denotes the diameter of the ith sensing cage, Pᵢ denotes the pitch of the helical structure on the ith sensing cage, l denotes the length of the optical fiber from the starting part of the first sensing cage to the input port of the distributed temperature sensing system, p₀′ denotes the length of a part not exceeding the length of the pitch, d′ denotes the diameter corresponding to a part not exceeding the length of a single turn of the helical line, and lᵢ denotes the optical fiber length between the starting end of the ith sensing cage and a demodulator.

In S3, the optical fiber is connected to a distributed temperature sensing system, the initial value of the distributed temperature sensing system is calibrated, and the initial moisture field of the porous medium is measured before polyurethane infiltration.

In S4, during the process of the polyurethane infiltration, temperature transmission fluctuations along the optical fiber during polyurethane diffusion in the porous medium are monitored by using the distributed temperature sensing system, and a post-infiltration moisture field in the stabilized state of the temperature transmission fluctuations is acquired.

In S5, a change in water content is analyzed based on the initial moisture field and the post-infiltration moisture field, and a polyurethane diffusion distribution field in the porous medium is identified in conjunction with the diffusion model.

In this embodiment, analyzing the change in the water content based on the initial moisture field and the post-infiltration moisture field and identifying the polyurethane diffusion distribution field in the porous medium in conjunction with the diffusion model includes determining a water content reduction region based on the initial moisture field and the post-infiltration moisture field; determining a region with reduced thermal conductivity in the porous medium based on a function relationship between a thermal conductivity and the water content in the water content reduction region; and identifying the polyurethane diffusion distribution field in the porous medium in conjunction with the diffusion model based on the region with reduced thermal conductivity in the porous medium.

In this embodiment, identifying the polyurethane diffusion distribution field in the porous medium in conjunction with the diffusion model based on the region with reduced thermal conductivity in the porous medium includes mapping premeasured fiber length data of the at least one sensing cage to the spatial Cartesian coordinate system of the porous medium to obtain three-dimensional structure data of the porous medium, where the fiber length data of the at least one sensing cage includes the winding length of the optical fiber on each sensing cage, the length of the optical fiber connecting adjacent sensing cages, and the length of the optical fiber from the starting part of the first sensing cage to the input port of the distributed temperature sensing system; identifying pore structure data of the porous medium in the region with reduced thermal conductivity based on the three-dimensional structure data of the porous medium and determining a heterogencity index of the porous medium in the region with reduced thermal conductivity based on the pore structure data by quantification using a statistical method; using the heterogeneity index of the porous medium as input, performing a micro molecular dynamics simulation in the region with reduced thermal conductivity, predicting a microscopic diffusion characteristic parameter of the polyurethane in a microstructure of the porous medium, and integrating the microscopic diffusion characteristic parameter into the diffusion model to obtain a polyurethane diffusion model that considers heterogeneity; establishing a chemical reaction dynamics model for the polyurethane diffusion in the porous medium, analyzing a time delay effect during the polyurethane diffusion in the region with reduced thermal conductivity by using the chemical reaction dynamics model, and extracting a time delay parameter during the polyurethane diffusion; and introducing the time delay parameter and using a Galerkin finite element method to perform a dynamic simulation on the polyurethane diffusion model that considers heterogeneity to capture a migration characteristic of the polyurethane in the porous medium to obtain the polyurethane diffusion distribution field that considers the time delay effect.

For example, in this embodiment, the water content change at each position is calculated based on the initial moisture field and the post-permeation moisture field. The region with reduced water content is identified. Using the function relationship between thermal conductivity and water content, a region with reduced thermal conductivity in the porous medium is determined. Thus, the region with reduced water content is converted into the region with reduced thermal conductivity. The three-dimensional structure data of the porous medium is obtained. The pore structure data of the porous medium in the region with reduced thermal conductivity is identified based on this three-dimensional structure data. For example, the pore structure data can include pore distribution, size, shape, and other structure data. Next, based on the pore structure data, a statistical method is used to quantify the heterogeneity index of the porous medium in the region with reduced thermal conductivity, such as permeability distribution. This embodiment uses the physical and chemical properties of the polyurethane and the porous medium to perform a molecular dynamics simulation in the region with reduced thermal conductivity. During the simulation, the heterogeneity index of the porous medium is introduced to predict the micro-diffusion characteristic parameter of the polyurethane in the microstructure of the porous medium. The micro-diffusion characteristic parameter is then transferred to the macroscopic scale and integrated into a macroscopic diffusion model. The model parameters (for example, diffusion coefficient or boundary condition) are adjusted using the micro-diffusion characteristic parameter to reflect the effect of the heterogeneity of the porous medium on the polyurethane diffusion, obtaining a diffusion model that accounts for heterogeneity. Furthermore, a chemical reaction dynamics model for polyurethane diffusion in the porous medium is established in this embodiment, considering processes such as physical adsorption and chemical reaction between the polyurethane and the medium. The chemical reaction dynamics model is used to analyze the time delay effect in the polyurethane diffusion process in the region with reduced thermal conductivity. Time delay parameters, such as reaction rate constant and adsorption equilibrium time, are extracted to quantitatively describe the non-instantaneous characteristics of the polyurethane diffusion in the porous medium. Finally, this embodiment uses the Galerkin finite element method to simulate the polyurethane diffusion model that considers heterogeneity, and the time delay parameter is incorporated in the simulation process to capture the migration characteristics of the polyurethane in the porous medium to obtain the polyurethane diffusion distribution field that considers the time delay effect. By introducing the heterogeneity of the porous medium and considering the time delay effect in this embodiment, the diffusion behavior of the polyurethane in the porous medium can be more accurately predicted to obtain the polyurethane diffusion distribution field.

It is to be noted that the heterogeneity of the porous medium introduced in this embodiment mainly refers to the unevenness of the porous medium in the physical, chemical, or structural properties, such as the unevenness in the pore distribution and connectivity of the porous medium. In this embodiment, the corresponding geometric features of the porous medium can be extracted through pore structure data, and the heterogeneity indexes of the porous medium can be obtained by quantifying these geometric features by using a statistical method. Those skilled in the art may use other methods to calculate the heterogeneity indexes of the porous medium, not limited to this embodiment of the present application. By introducing heterogeneity indexes for the porous medium, the complex diffusion behavior within the porous medium can be more effectively described. In the polyurethane diffusion process in the porous medium, the time delay effect in the diffusion process is caused by various factors, such as the chemical reaction time of the polyurethane and the increased diffusion resistance and time due to the complexity of the medium's structure. This embodiment introduces the time delay effect into the polyurethane diffusion model, enabling a more accurate description and prediction of the non-instantaneous characteristics in the actual diffusion process.

In summary, this embodiment connects the distributed optical fiber to the Distributed Temperature Sensing (DTS) system via a jumper cable. The DTS can capture and transmit the changes in temperature at each position of the optical fiber in real time, thereby displaying the changes in temperature in real time. The DTS system is then calibrated, the spatial resolution, time resolution, and heating power of the system are set, and the initial value of the system is calibrated. The DTS system is started, and moisture measurement is performed to obtain the initial moisture field M1. During the polyurethane permeation process, the DTS system is used to monitor the temperature changes of the distributed optical fiber in real time during the polyurethane diffusion. After the temperature stabilizes, the moisture field is measured again to obtain the post-permeation moisture field M2 under a stable temperature state. Based on the relationship between thermal conductivity and moisture content, the regions with reduced moisture content in M1 and M2, that is, the regions with reduced thermal conductivity, are compared so that the polyurethane diffusion in the porous medium is determined. In this embodiment, the polyurethane diffusion behavior includes, but is not limited to, the diffusion path, range, and morphology of the polyurethane in the porous medium. For clarity, the following explains the heat source theory and the monitoring principle of the polyurethane diffusion distribution field in the theory of polyurethane diffusion distribution field.

### (1) Heat Source Theory

In a homogeneous and isotropic porous medium with uniform initial temperature, the heat transfer can be described by Fourier's law:

$$c \frac{\partial T}{\partial t} = \frac{\partial T}{\partial x} ( λ \frac{\partial T}{\partial x} ) + \frac{\partial T}{\partial y} ( λ \frac{\partial T}{\partial y} ) + \frac{\partial T}{\partial z} ( λ \frac{\partial T}{\partial z} )$$

For a heat pulse generated by an infinitely long heat source, if the influence of radial dimensions and cable material is ignored, the process of heat diffusion to the surrounding during heating can be expressed as follows:

$$Δ T = \frac{P}{4 πλ S} lnt + b , 0 \leq t \leq {t}_{0}$$

Here c denotes the specific heat capacity (in units of J/(kg·° C.)), T denotes temperature, t denotes time, ∂T/∂x, ∂T/∂y, and ∂T/∂z denote the partial derivative of temperature in the x-axis, the partial derivative of temperature in the y-axis, and the partial derivative of temperature in the z-axis, respectively. t₀ denotes the heating time. λ denotes the thermal conductivity (in units of W/(m° C.), P denotes the heating power (in units of J/(m s) per unit length of the linear heat source, S denotes the distance (in units of m) from the measurement point to the heat source, and b denotes a constant.

When the radius of the heat source is considered, the heat diffusion during the heating process can be expressed as:

$$Δ T = \frac{P}{4 πλ S} lnt + b + P [ R + \frac{1}{4 πλ} ln ( \frac{4 r}{{S}^{2}} - γ ) ] , 0 \leq t \leq {t}_{0}$$

R and γ denote interface impedance (in units of m²° C./W) and Euler's constant, respectively, which are fitted by the least squares method; and r denotes the radius (in units of m) of the heat source, which is obtained by numerical simulation.

### (2) Principle of Monitoring the Polyurethane Diffusion Distribution Field

Before grouting, the porous medium contains a moisture field. First, the initial moisture field M₁ of the porous medium is calibrated using the Actively Heated Fiber Optic method (AHFO). At this point, the geotechnical material consists of air, geotechnical particles, and water, and the thermal conductivity of the gas is relatively small and can be neglected. This example uses the geotechnical thermal conductivity prediction model established by Côté and Konrad (hereinafter referred to as the CK model) to establish the relationship between geotechnical thermal conductivity and saturation. The change in saturation directly affects the value of the thermal conductivity. In the porous medium, the increase or decrease of moisture directly affects the saturation of the geotechnical material, meaning the change in moisture content directly reflects the change in saturation. Therefore, through these two relationships, this embodiment indirectly correlates the thermal conductivity with the moisture content. The change in the moisture content causes a change in saturation, affecting the value of the thermal conductivity. The relationship between moisture content and saturation is a known technology and thus is not repeated here. The calculation formula for the thermal conductivity of the geotechnical material before grouting is as follows:

$${λ}_{1} = ( {λ}_{sat} - {λ}_{dry} ) {K}_{e 1} + {λ}_{dry}$$

$${K}_{e 1} = \frac{a {S}_{r 1}}{1 + ( 1 + a ) {S}_{r 1}}$$

Here λ₁ denotes the thermal conductivity of the geotechnical material, λₛₐₜ denotes the thermal conductivity of the saturated geotechnical material, λ_{dry} denotes the thermal conductivity of the dry geotechnical material, Kₑ, denotes the normalized thermal conductivity before grouting, a denotes the weighting coefficient, which is a parameter related to the geotechnical composition, structure, and temperature, and Sᵣ, denotes the degree of geotechnical saturation (%) before grouting.

The thermal conductivity λₛₐₜ of the saturated geotechnical material under non-freezing conditions is:

$${λ}_{sat} = {λ}_{s}^{1 - n} {λ}_{w}^{n}$$

Here λ_{w} denotes the thermal conductivity of water, λₛ denotes the thermal conductivity of geotechnical particles, and λₙ denotes the geotechnical porosity (%).

$${λ}_{s} = {\prod }_{j} {λ}_{{m}_{j}}^{{x}_{j}}$$

$${\sum }_{j} {x}_{j} = 1$$

Here λₘⱼ denotes the thermal conductivity of each mineral component, and xⱼ denotes the volume fraction (%) of each mineral component.

The thermal conductivity of dry geotechnical material is:

$${λ}_{dry} = 1 {0}^{- η n} χ$$

Here χ and η are each a material parameter.

For the thermal conductivity λₚ₁ of the polyurethane during the phase change process, before grouting, the probe method is used. After mixing the polyurethane and water in a preset ratio by using the probe method, the probe is inserted to measure λₚ₁. The measurement time is approximately 10 minutes. Since the polyurethane releases a large amount of heat when initially mixed with water, causing a rise in temperature and affecting data accuracy, the heating of the probe starts 3 minutes after mixing. The measurement is performed for around 13 minutes for measuring the thermal conductivity λₚ₁ of the polyurethane during the phase change process.

When grouting begins, polyurethane slowly permeates into the porous medium, reacts with water, and undergoes a phase change, causing the thermal conductivity of the porous medium to change. During the grouting process, water in the porous medium is continuously displaced and reacted, and changes in the moisture field. It is difficult to accurately determine the saturation of the porous medium during the phase change process. Therefore, it is assumed that the degree of saturation of the porous medium during the phase change is the saturation Sᵣ₂ after the reaction. Since the disturbance caused by the grouting permeation to the porous medium is minimal, it is considered that no displacement occurs in the porous medium during the permeation, displacement, and solidification of the polyurethane. Thus, during the phase change process, the thermal conductivity λ₂ in the porous medium calculated using the CK model may be as follows:

$${λ}_{2} = ( {λ}_{sat} - {λ}_{dry} ) {K}_{e 2} + {λ}_{dry} + {λ}_{p 1}$$

$${K}_{e 2} = \frac{a {S}_{r 2}}{1 + ( 1 + a ) {S}_{r 2}}$$

Here Kₑ₂ denotes the normalized thermal conductivity during the grouting process and after the grout has solidified, λₚ₁ denotes the thermal conductivity of the polyurethane during the phase change process, and Sᵣ₂ denotes geotechnical saturation (%) during the grouting process (%).

At this point, the DTS system is simultaneously activated to monitor the changes in the temperature field in the porous medium in real time, enabling real-time monitoring of the grout diffusion.

After the grout cures, the volume fraction of the pores in the porous medium is replaced by the polyurethane, and water and air are displaced by the polyurethane, causing the moisture field to redistribute. At this point, the thermal conductivity λ₃ of the solidified body can be expressed as:

$${λ}_{3} = ( {λ}_{sat} - {λ}_{dry} ) {K}_{e 2} + {λ}_{dry} + {λ}_{p 2}$$

Here λₚ₂ denotes the thermal conductivity of the polyurethane after curing, which can be measured using a Hot Disk thermal constant analyzer or a corundum tube thermal probe method.

At this point, the AHFO method is used again to monitor the reconstructed moisture field to obtain the post-permeation moisture field M₂. By using AHFO to perform monitoring before penetration and after curing and by comparing the initial moisture field M₁ and the post-permeation moisture field M₂, the region with reduced moisture content can be determined. For example, it is feasible to calculate the moisture content change of each monitoring point by using the initial moisture field M₁ and the post-permeation moisture field M₂ measured by AHFO before and after grouting, thereby identifying the region with significantly reduced moisture content. Then it is feasible to analyze changes in the thermal conductivity to infer the polyurethane diffusion condition. When λ₃<λ₁, that is the polyurethane diffusion distribution field.

### (II) Design and Calibration of the Polyurethane Diffusion Distribution Field Distributed Optical Fiber Sensing System

As shown in FIG. 5, the polyurethane diffusion distribution field distributed temperature sensing system includes a distributed temperature sensing system 1, a host computer 2, a data transmission line 3, a data processor 4, a time control switch 5, a DC power supply 6, copper wires 7, a porous medium 8, optical fibers 9, and a sensing cage 10. Here the heating module that includes the DC power supply and the time control switch is configured to heat the optical fibers. The time control switch is configured to precisely control the heating time, with an accuracy requirement of 1 second. The distributed temperature sensing system is configured to monitor changes in temperature. The demodulation module of the distributed temperature sensing system is configured to convert the measured Raman light signal into temperature information. The data transmission line sends the data to the terminal by using the mobile 5G network. The data processor has two main functions: first, a control function to ensure the coordinated operation between all modules; second, a data post-processing function to convert temperature fluctuation information into changes in the moisture content and, based on this, infer the polyurethane diffusion distribution field.

In terms of system calibration, the Active Heated Fiber Optic (AHFO) method is used to calibrate the initial moisture field of the porous medium, yielding the initial moisture field. During the infiltration process, the Distributed Temperature Sensing (DTS) system is started synchronously to monitor real-time changes in temperature and record temperature changes caused by polyurethane reaction and diffusion, thus enabling real-time monitoring of the grout's diffusion in the porous medium. In the post-processing stage, after the grouting is completed, the post-permeation moisture field M₂ is measured again. Based on the function relationship between thermal conductivity and moisture content, the region with reduced moisture content is compared to identify the corresponding region with decreased thermal conductivity, thereby identifying the polyurethane diffusion distribution field.

The traditional method of analyzing a grouting project based on the optical fiber sensing technology primarily involves substituting temperature data monitored by the optical fiber sensing technology into MATLAB to generate a grout temperature field cloud map or directly using temperature data as the basis for judgment to visually display the diffusion range of the grout. However, this traditional method is susceptible to various factors such as external environmental temperature, the thermal conductivity of the medium, and temperature loss during the grouting process, which may cause a deviation between the temperature field and the actual grout diffusion range, leading to significant measurement errors. Additionally, the flow of polyurethane in a porous medium is a complex physical process involving fluid mechanics, thermodynamics, and the physical properties of the porous medium. Considering the thermal effects during the polyurethane curing process, directly determining the diffusion range of the grout based on changes in temperature makes it difficult for the temperature data to accurately reflect the diffusion situation. Therefore, the method for monitoring polyurethane diffusion in a porous medium according to this embodiment monitors the moisture field changes in the porous medium. When combining the relationship between thermal conductivity and moisture content, this method allows for a more accurate analysis of the grout diffusion behavior in the porous medium. This method is based on physical principles and can more accurately reflect the internal state changes of the porous medium, providing scientific guidance for the design and construction of the grouting project.

This embodiment of the present application provides a method for monitoring polyurethane diffusion in a porous medium. The method includes winding a distributed optical fiber around at least one sensing cage according to a predetermined helical parameter to form a helical structure; establishing a spatial Cartesian coordinate system for the porous medium with a polyurethane infiltration point as an origin and mapping coordinates of each temperature measurement point on the helical structure to the spatial Cartesian coordinate system of the porous medium; connecting the optical fiber to a distributed temperature sensing system, calibrating an initial value of the distributed temperature sensing system, and measuring an initial moisture field of the porous medium before polyurethane infiltration; during the polyurethane diffusion that occurs in the polyurethane infiltration in the porous medium, monitoring temperature transmission fluctuations along the optical fiber by using the distributed temperature sensing system and acquiring a post-infiltration moisture field in a stabilized state of the temperature transmission fluctuations; and analyzing the change in water content based on the initial moisture field and the post-infiltration moisture field and identifying a polyurethane diffusion distribution field in the porous medium in conjunction with the diffusion model. Compared with the related art, the method of this embodiment of the present application uses the distributed temperature sensing system to monitor temperature changes of the distributed optical fiber in real time during the polyurethane diffusion process. Based on the relationship between the thermal conductivity and the moisture content, a comprehensive and accurate evaluation of polyurethane diffusion in the porous medium is achieved after the change in the moisture field of the porous medium is analyzed. This method not only improves the comprehensiveness and cost-effectiveness of the monitoring, but also avoids significant errors caused by directly using temperature measurement to determine the diffusion range, thereby enhancing the accuracy of the monitoring. This method has a broad application prospect.

In addition, compared with the related art, the method uses the distributed fiber optic sensing technology to monitor the change in temperature along the optical fiber in the polyurethane diffusion process in the porous medium in real time, enabling large-area, low-cost, and efficient monitoring of the porous medium. This improves the comprehensiveness and cost-effectiveness of monitoring. Additionally, by using the physical property of change in thermal conductivity after polyurethane curing and comparing the moisture field change in the porous medium before and after grouting, it is possible to indirectly determine the diffusion of the grout in the porous medium. This allows for accurate monitoring of polyurethane diffusion in the porous medium, providing strong technical support for engineering practice.

It is to be noted that the sequence numbers of the preceding processes do not indicate the order of execution. The execution order of these processes should be determined based on their functions and intrinsic logic and should not impose any limitation on the implementation process of this embodiment of the present application.

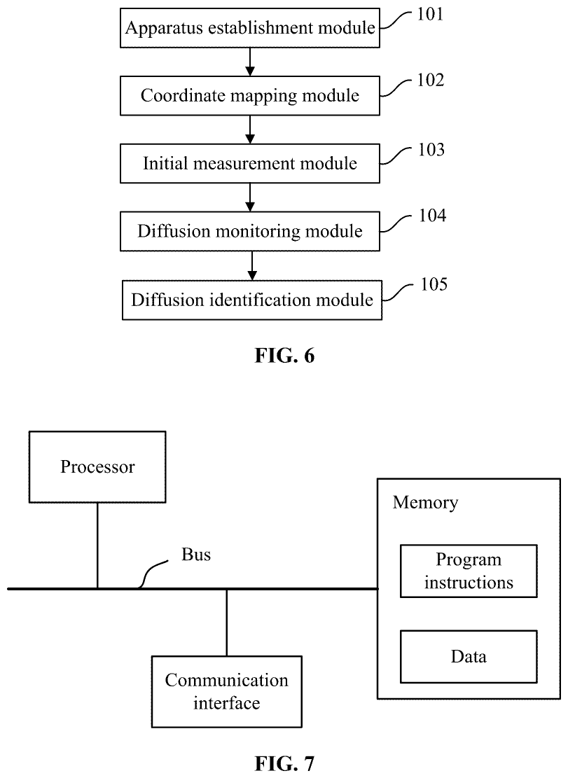

In an embodiment, as shown in FIG. 6, an apparatus for monitoring polyurethane diffusion in a porous medium is provided. The apparatus includes an apparatus establishment module 101, a coordinate mapping module 102, an initial measurement module 103, a diffusion monitoring module 104, and a diffusion identification module 105.

The apparatus establishment module 101 is configured to select a diffusion model according to a diffusion characteristic of polyurethane in the porous medium and wind a distributed optical fiber around at least one sensing cage according to a predetermined helical parameter to form a helical structure.

The coordinate mapping module 102 is configured to establish a spatial Cartesian coordinate system for the porous medium with a polyurethane infiltration point as an origin and map coordinates of each temperature measurement point on the helical structure to the spatial Cartesian coordinate system of the porous medium.

The initial measurement module 103 is configured to connect the optical fiber to a distributed temperature sensing system, calibrate an initial value of the distributed temperature sensing system, and measure an initial moisture field of the porous medium before polyurethane infiltration.

The diffusion monitoring module 104 is configured to, during the polyurethane diffusion that occurs in the polyurethane infiltration in the porous medium, monitor temperature transmission fluctuations along the optical fiber by using the distributed temperature sensing system and acquire a post-infiltration moisture field in a stabilized state of the temperature transmission fluctuations.

The diffusion identification module 105 is configured to analyze a change in water content based on the initial moisture field and the post-infiltration moisture field and identify a polyurethane diffusion distribution field in the porous medium in conjunction with the diffusion model.

For limitations on an apparatus for monitoring polyurethane diffusion in a porous medium, see the preceding limitations on the method for monitoring polyurethane diffusion in a porous medium. Those skilled in the art can recognize that the various modules and steps described in the embodiments disclosed in the present application can be implemented by hardware, software, or a combination of both. Whether these functions are executed via hardware or software depends on the specific application of the technical solution and design constraints. Professionals in the field may use different methods to implement the described functions for each application, but such implementations should not be considered as going beyond the scope of the present application.

This embodiment of the present application provides an apparatus for monitoring polyurethane diffusion in a porous medium. The apparatus includes an apparatus establishment module, a coordinate mapping module, an initial measurement module, a diffusion monitoring module, and a diffusion identification module. The apparatus establishment module is configured to wind a distributed optical fiber around at least one sensing cage according to a predetermined helical parameter to form a helical structure. The coordinate mapping module is configured to establish a spatial Cartesian coordinate system for the porous medium with a polyurethane infiltration point as an origin and map coordinates of each temperature measurement point on the helical structure to the spatial Cartesian coordinate system of the porous medium. The initial measurement module is configured to connect the optical fiber to a distributed temperature sensing system, calibrate an initial value of the distributed temperature sensing system, and measure an initial moisture field of the porous medium before polyurethane infiltration. The diffusion monitoring module is configured to, during the polyurethane diffusion that occurs in the polyurethane infiltration in the porous medium, monitor temperature transmission fluctuations along the optical fiber by using the distributed temperature sensing system and acquire a post-infiltration moisture field in a stabilized state of the temperature transmission fluctuations. The diffusion identification module is configured to analyze a change in water content based on the initial moisture field and the post-infiltration moisture field and identify a polyurethane diffusion distribution field in the porous medium in conjunction with the diffusion model. Compared with the related art, the apparatus of this embodiment of the present application uses the distributed temperature sensing system to monitor temperature changes of the distributed optical fiber in real time during the polyurethane diffusion process. Based on the relationship between the thermal conductivity and the moisture content, a comprehensive and accurate evaluation of polyurethane diffusion in the porous medium is achieved. This apparatus has a broad application prospect.

FIG. 7 illustrates a computer device according to an embodiment of the present application. The computer device includes a memory, a processor, and a transceiver. They are connected via a bus. The memory is configured to store a set of computer program instructions and data and transfer the stored data to the processor. The processor can execute the program instructions stored in the memory to perform the steps of the preceding method.

The memory may include at least one of a volatile memory or a nonvolatile memory. The processor may be a central processing unit, a microprocessor, an application-specific integrated circuit, a programmable logic device, or a combination thereof.

Illustratively but not restrictively, the programmable logic device may be a complex programmable logic device, a field-programmable logic gate array, a generic array logic, or any combination thereof.

Additionally, the memory may be a physically independent unit or may be integrated with the processor.

It is to be understood by those skilled in the art that the structure illustrated in FIG. 7 is a block diagram of a portion of the structure related to the solution of the present application and does not limit the computer device to which the solution of the present application is applied, and the computer device may include more or fewer components than those illustrated, may combine some components, or may have the same component layout.

An embodiment of the present application provides a computer-readable storage medium. The medium stores computer-executable instructions for executing the preceding method when executed by a processor.

Embodiments of the present application provide a method and apparatus for monitoring polyurethane diffusion in a porous medium, a device, and a medium. The method for monitoring polyurethane diffusion in a porous medium combines the optical fiber technology with the thermal conductivity change characteristics after polyurethane curing to achieve high-precision, real-time, and comprehensive monitoring of polyurethane diffusion in the porous medium. This method not only enables low-cost and high-efficiency monitoring but also enhances the accuracy and comprehensiveness of the monitoring.

The preceding embodiments may be implemented in whole or in part by software, hardware, firmware, or any combination thereof. Implementation by software may be implementation in whole or in part in the form of a computer program product. The computer program product includes one or more computer instructions. When the compute loads and executes the computer program instructions, the flows or functions described in accordance with embodiments of the present application are generated in whole or in part. The computer may be a general-purpose computer, a special-purpose computer, a computer network, or other programmable apparatuses. The computer instructions may be stored in a computer-readable storage medium or transmitted from one computer-readable storage medium to another computer-readable storage medium. For example, the computer instructions may be transmitted from one web site, computer, server, or data center to another web site, computer, server, or data center in a wired manner (for example, via a coaxial cable, via an optical fiber, or via a digital subscriber line (DSL)) or in a wireless (for example, infrared, wireless, or microwave) manner. The computer-readable storage medium may be any available medium that can be accessed by a computer or an integrated data storage device such as a server, a data center, or the like that includes one or more available media. The available medium may be for example, a magnetic medium (for example, a floppy disk, a hard disk, or a magnetic tape), an optical medium (for example, a DVD), or a semiconductor medium (for example, a solid state disk (SSD)).

It is to be understood by those having ordinary skill in the art that all or part of the processes in the methods of the embodiments described above may be completed by instructing related hardware through computer programs, the computer programs may be stored in a computer-readable storage medium, and during the execution of the computer programs, the processes in the method embodiments described above may be included.

The preceding embodiments are preferred embodiments of the present application. These embodiments are described in detail, but cannot be construed as limiting the scope of the present application. It is to be noted that for those skilled in the art, a number of improvements and modifications can be made without departing from the principle of the present application, and these improvements and modifications are within the scope of the present application. Therefore, the protection scope of the present application is subject to the scope of the appended claims.

What is claimed is:

1. A method for monitoring polyurethane diffusion in a porous medium, comprising:
selecting a diffusion model according to a diffusion characteristic of polyurethane in the porous medium and winding a distributed optical fiber around at least one sensing cage according to a predetermined helical parameter to form a helical structure;
establishing a spatial Cartesian coordinate system for the porous medium with a polyurethane infiltration point as an origin and mapping coordinates of each temperature measurement point on the helical structure to the spatial Cartesian coordinate system of the porous medium;
connecting the optical fiber to a distributed temperature sensing system, calibrating an initial value of the distributed temperature sensing system, and measuring an initial moisture field of the porous medium before polyurethane infiltration;
during the polyurethane diffusion that occurs in the polyurethane infiltration in the porous medium, monitoring temperature transmission fluctuations along the optical fiber by using the distributed temperature sensing system and acquiring a post-infiltration moisture field in a stabilized state of the temperature transmission fluctuations; and
analyzing a change in water content based on the initial moisture field and the post-infiltration moisture field and identifying a polyurethane diffusion distribution field in the porous medium in conjunction with the diffusion model.

2. The method for monitoring polyurethane diffusion in a porous medium according to claim 1, wherein the helical parameter comprises a number of fiber winding turns, a pitch, and a helical angle of the helical structure on each of the at least one sensing cage, wherein mathematical expressions of the number of fiber winding turns, the pitch, and the helical angle are as follows:
$$N = \frac{H}{P}$$
$$P = \frac{π DH}{\sqrt{( L + H ) ( L - H )}}$$
$$θ = arctan ( \frac{P}{π D} )$$
$$0 \leq θ < \frac{π}{2}$$
wherein for each of the at least one sensing cage, N denotes the number of fiber winding turns, H denotes a height of the sensing cage, P denotes the pitch, D denotes a diameter of the sensing cage, l denotes an internal fiber winding length on the sensing cage, and θ denotes the helical angle.

3. The method for monitoring polyurethane diffusion in a porous medium according to claim 1, wherein when one sensing cage is provided, the coordinates of each temperature measurement point on the helical structure mapped to the spatial Cartesian coordinate system of the porous medium are as follows:
$$\{ \begin{matrix}x = \frac{d}{2} * cos θ \\ y = \frac{d}{2} * sin θ \\ z = n * P + {p}_{0}\end{matrix}$$
$$wherein$$
$$n \sqrt{{( π D )}^{2} + {P}^{2}} \leq L - {l}_{1} \leq ( n + 1 ) \sqrt{{( π D )}^{2} + {P}^{2}}$$
$${p}_{0} = \frac{P}{L} * ( L - {l}_{1} - n \sqrt{{( π D )}^{2} + {P}^{2}} )$$
$$d = \frac{D}{L} * ( L - {l}_{1} - n \sqrt{{( π D )}^{2} + {P}^{2}} )$$
wherein (x, y, z) denote the coordinates of each temperature measurement point on the helical structure mapped to the spatial Cartesian coordinate system of the porous medium, θ denotes a helical angle, p₀ and d are intermediate variables, l₁ denotes an optical fiber length between a starting end of the sensing cage and a demodulator, l denotes a fiber winding length on the sensing cage, n denotes a serial number of a helical turn where a point is located on the helical structure, D denotes a diameter of the sensing cage, and P denotes a pitch.

4. The method for monitoring polyurethane diffusion in a porous medium according to claim 1, wherein when at least two sensing cages are provided, the coordinates of each temperature measurement point on the helical structure mapped to the spatial Cartesian coordinate system of the porous medium are as follows:
$$\{ \begin{matrix}x = \frac{{d}^{′}}{2} * cos {θ}_{i} \\ y = \frac{{d}^{′}}{2} * sin {θ}_{i} \\ z = {n}_{i} * {P}_{i} + {p}_{0}^{′}\end{matrix}$$
$$wherein$$
$${p}_{0}^{′} = \frac{{P}_{i}}{{L}_{i}} * ( {L}_{i} - {\sum }_{i = 1}^{m} ( {l}_{i} + {L}_{i} ) - {n}_{i} \sqrt{{( π {D}_{i} )}^{2} + {P}_{i}^{2}} )$$
$${d}^{′} = \frac{{D}_{i}}{{L}_{i}} * ( {L}_{i} - {\sum }_{i = 1}^{m} ( {l}_{i} + {L}_{i} ) - {n}_{i} \sqrt{{( π {D}_{i} )}^{2} + {P}_{i}^{2}} )$$
wherein (x, y, z) denote the coordinates of each temperature measurement point on the helical structure mapped to the spatial Cartesian coordinate system of the porous medium, i denotes an ith sensing cage of the at least two sensing cages, l≤i≤m, m denotes a number of the at least two sensing cages, θᵢ denotes a helical angle of the helical structure on the ith sensing cage, p₀′ and d′ are intermediate variables, Lᵢ denotes an internal fiber winding length on the ith sensing cage, lᵢ denotes an optical fiber length between a starting end of the ith sensing cage and a demodulator, nᵢ denotes a serial number of a helical turn where a temperature measurement point is located on the helical structure of the ith sensing cage, Dᵢ denotes a diameter of the ith sensing cage, and Pᵢ denotes a pitch of the helical structure on the ith sensing cage.

5. The method for monitoring polyurethane diffusion in a porous medium according to claim 1, wherein analyzing the change in the water content based on the initial moisture field and the post-infiltration moisture field and identifying the polyurethane diffusion distribution field in the porous medium in conjunction with the diffusion model comprises:
determining a water content reduction region based on the initial moisture field and the post-infiltration moisture field;
determining a region with reduced thermal conductivity in the porous medium based on a function relationship between a thermal conductivity and the water content according to the water content reduction region; and
identifying the polyurethane diffusion distribution field in the porous medium in conjunction with the diffusion model based on the region with reduced thermal conductivity in the porous medium.

6. The method for monitoring polyurethane diffusion in a porous medium according to claim 5, wherein the diffusion model comprises a spherical diffusion model or a column-hemispherical diffusion model.

7. The method for monitoring polyurethane diffusion in a porous medium according to claim 5, wherein identifying the polyurethane diffusion distribution field in the porous medium in conjunction with the diffusion model based on the region with reduced thermal conductivity in the porous medium comprises:
mapping premeasured fiber length data of the at least one sensing cage to the spatial Cartesian coordinate system of the porous medium to obtain three-dimensional structure data of the porous medium;
identifying pore structure data of the porous medium in the region with reduced thermal conductivity based on the three-dimensional structure data of the porous medium and determining a heterogeneity index of the porous medium in the region with reduced thermal conductivity based on the pore structure data by quantification using a statistical method;
using the heterogeneity index of the porous medium as input, performing a micro molecular dynamics simulation in the region with reduced thermal conductivity, predicting a microscopic diffusion characteristic parameter of the polyurethane in a microstructure of the porous medium, and integrating the microscopic diffusion characteristic parameter into the diffusion model to obtain a polyurethane diffusion model that considers heterogeneity;
establishing a chemical reaction dynamics model for the polyurethane diffusion in the porous medium, analyzing a time delay effect during the polyurethane diffusion in the region with reduced thermal conductivity by using the chemical reaction dynamics model, and extracting a time delay parameter during the polyurethane diffusion; and
introducing the time delay parameter and using a Galerkin finite element method to perform a dynamic simulation on the polyurethane diffusion model that considers heterogeneity to capture a migration characteristic of the polyurethane in the porous medium to obtain the polyurethane diffusion distribution field that considers the time delay effect.

8. A computer device, comprising a processor and a memory, wherein the processor is connected to the memory, the memory is configured to store a computer program, and the processor is configured to execute the computer program to cause the computer device to perform the following steps:
selecting a diffusion model according to a diffusion characteristic of polyurethane in the porous medium and winding a distributed optical fiber around at least one sensing cage according to a predetermined helical parameter to form a helical structure;
establishing a spatial Cartesian coordinate system for the porous medium with a polyurethane infiltration point as an origin and mapping coordinates of each temperature measurement point on the helical structure to the spatial Cartesian coordinate system of the porous medium;
connecting the optical fiber to a distributed temperature sensing system, calibrating an initial value of the distributed temperature sensing system, and measuring an initial moisture field of the porous medium before polyurethane infiltration;
during the polyurethane diffusion that occurs in the polyurethane infiltration in the porous medium, monitoring temperature transmission fluctuations along the optical fiber by using the distributed temperature sensing system and acquiring a post-infiltration moisture field in a stabilized state of the temperature transmission fluctuations; and
analyzing a change in water content based on the initial moisture field and the post-infiltration moisture field and identifying a polyurethane diffusion distribution field in the porous medium in conjunction with the diffusion model.

9. The device according to claim 8, wherein the helical parameter comprises a number of fiber winding turns, a pitch, and a helical angle of the helical structure on each of the at least one sensing cage, wherein mathematical expressions of the number of fiber winding turns, the pitch, and the helical angle are as follows:
$$N = \frac{H}{P}$$
$$P = \frac{π DH}{\sqrt{( L + H ) ( L - H )}}$$
$$θ = arctan ( \frac{P}{π D} )$$
$$0 \leq θ < \frac{π}{2}$$
wherein for each of the at least one sensing cage, N denotes the number of fiber winding turns, H denotes a height of the sensing cage, P denotes the pitch, D denotes a diameter of the sensing cage, l denotes an internal fiber winding length on the sensing cage, and θ denotes the helical angle.

10. The device according to claim 8, wherein when one sensing cage is provided, the coordinates of each temperature measurement point on the helical structure mapped to the spatial Cartesian coordinate system of the porous medium are as follows:
$$\{ \begin{matrix}x = \frac{d}{2} * cos θ \\ y = \frac{d}{2} * sin θ \\ z = n * P + {p}_{0}\end{matrix}$$
$$wherein$$
$$n \sqrt{{( π D )}^{2} + {P}^{2}} \leq L - {l}_{1} \leq ( n + 1 ) \sqrt{{( π D )}^{2} + {P}^{2}}$$
$${p}_{0} = \frac{P}{L} * ( L - {l}_{1} - n \sqrt{{( π D )}^{2} + {P}^{2}} )$$
$$d = \frac{D}{L} * ( L - {l}_{1} - n \sqrt{{( π D )}^{2} + {P}^{2}} )$$
wherein (x, y, z) denote the coordinates of each temperature measurement point on the helical structure mapped to the spatial Cartesian coordinate system of the porous medium, θ denotes a helical angle, p₀ and d are intermediate variables, l₁ denotes an optical fiber length between a starting end of the sensing cage and a demodulator, l denotes a fiber winding length on the sensing cage, n denotes a serial number of a helical turn where a point is located on the helical structure, D denotes a diameter of the sensing cage, and P denotes a pitch.

11. The device according to claim 8, wherein when at least two sensing cages are provided, the coordinates of each temperature measurement point on the helical structure mapped to the spatial Cartesian coordinate system of the porous medium are as follows:
$$\{ \begin{matrix}x = \frac{{d}^{′}}{2} * cos {θ}_{i} \\ y = \frac{{d}^{′}}{2} * sin {θ}_{i} \\ z = {n}_{i} * {P}_{i} + {p}_{0}^{′}\end{matrix}$$
$$wherein$$
$${p}_{0}^{′} = \frac{{P}_{i}}{{L}_{i}} * ( {L}_{i} - {\sum }_{i = 1}^{m} ( {l}_{i} + {L}_{i} ) - {n}_{i} \sqrt{{( π {D}_{i} )}^{2} + {P}_{i}^{2}} )$$
$${d}^{′} = \frac{{D}_{i}}{{L}_{i}} * ( {L}_{i} - {\sum }_{i = 1}^{m} ( {l}_{i} + {L}_{i} ) - {n}_{i} \sqrt{{( π {D}_{i} )}^{2} + {P}_{i}^{2}} )$$
wherein (x, y, z) denote the coordinates of each temperature measurement point on the helical structure mapped to the spatial Cartesian coordinate system of the porous medium, i denotes an ith sensing cage of the at least two sensing cages, l≤i≤m, m denotes a number of the at least two sensing cages, θᵢ denotes a helical angle of the helical structure on the ith sensing cage, p₀′ and d′ are intermediate variables, Lᵢ denotes an internal fiber winding length on the ith sensing cage, lᵢ denotes an optical fiber length between a starting end of the ith sensing cage and a demodulator, nᵢ denotes a serial number of a helical turn where a temperature measurement point is located on the helical structure of the ith sensing cage, Dᵢ denotes a diameter of the ith sensing cage, and Pᵢ denotes a pitch of the helical structure on the ith sensing cage.

12. The device according to claim 8, wherein analyzing the change in the water content based on the initial moisture field and the post-infiltration moisture field and identifying the polyurethane diffusion distribution field in the porous medium in conjunction with the diffusion model comprises:
determining a water content reduction region based on the initial moisture field and the post-infiltration moisture field;
determining a region with reduced thermal conductivity in the porous medium based on a function relationship between a thermal conductivity and the water content according to the water content reduction region; and
identifying the polyurethane diffusion distribution field in the porous medium in conjunction with the diffusion model based on the region with reduced thermal conductivity in the porous medium.

13. The device according to claim 12, wherein the diffusion model comprises a spherical diffusion model or a column-hemispherical diffusion model.

14. The device according to claim 12, wherein identifying the polyurethane diffusion distribution field in the porous medium in conjunction with the diffusion model based on the region with reduced thermal conductivity in the porous medium comprises:
mapping premeasured fiber length data of the at least one sensing cage to the spatial Cartesian coordinate system of the porous medium to obtain three-dimensional structure data of the porous medium;
identifying pore structure data of the porous medium in the region with reduced thermal conductivity based on the three-dimensional structure data of the porous medium and determining a heterogeneity index of the porous medium in the region with reduced thermal conductivity based on the pore structure data by quantification using a statistical method;
using the heterogeneity index of the porous medium as input, performing a micro molecular dynamics simulation in the region with reduced thermal conductivity, predicting a microscopic diffusion characteristic parameter of the polyurethane in a microstructure of the porous medium, and integrating the microscopic diffusion characteristic parameter into the diffusion model to obtain a polyurethane diffusion model that considers heterogeneity;
establishing a chemical reaction dynamics model for the polyurethane diffusion in the porous medium, analyzing a time delay effect during the polyurethane diffusion in the region with reduced thermal conductivity by using the chemical reaction dynamics model, and extracting a time delay parameter during the polyurethane diffusion; and
introducing the time delay parameter and using a Galerkin finite element method to perform a dynamic simulation on the polyurethane diffusion model that considers heterogeneity to capture a migration characteristic of the polyurethane in the porous medium to obtain the polyurethane diffusion distribution field that considers the time delay effect.

15. A non-transitory computer-readable storage medium storing a computer program, wherein when executed, the computer program causes a processor to perform the following steps:
selecting a diffusion model according to a diffusion characteristic of polyurethane in the porous medium and winding a distributed optical fiber around at least one sensing cage according to a predetermined helical parameter to form a helical structure;
establishing a spatial Cartesian coordinate system for the porous medium with a polyurethane infiltration point as an origin and mapping coordinates of each temperature measurement point on the helical structure to the spatial Cartesian coordinate system of the porous medium;
connecting the optical fiber to a distributed temperature sensing system, calibrating an initial value of the distributed temperature sensing system, and measuring an initial moisture field of the porous medium before polyurethane infiltration;
during the polyurethane diffusion that occurs in the polyurethane infiltration in the porous medium, monitoring temperature transmission fluctuations along the optical fiber by using the distributed temperature sensing system and acquiring a post-infiltration moisture field in a stabilized state of the temperature transmission fluctuations; and
analyzing a change in water content based on the initial moisture field and the post-infiltration moisture field and identifying a polyurethane diffusion distribution field in the porous medium in conjunction with the diffusion model.

16. The storage medium according to claim 15, wherein the helical parameter comprises a number of fiber winding turns, a pitch, and a helical angle of the helical structure on each of the at least one sensing cage, wherein mathematical expressions of the number of fiber winding turns, the pitch, and the helical angle are as follows:
$$N = \frac{H}{P}$$
$$P = \frac{π DH}{\sqrt{( L + H ) ( L - H )}}$$
$$θ = arctan ( \frac{P}{π D} )$$
$$0 \leq θ < \frac{π}{2}$$
wherein for each of the at least one sensing cage, N denotes the number of fiber winding turns, H denotes a height of the sensing cage, P denotes the pitch, D denotes a diameter of the sensing cage, l denotes an internal fiber winding length on the sensing cage, and θ denotes the helical angle.

17. The storage medium according to claim 15, wherein when one sensing cage is provided, the coordinates of each temperature measurement point on the helical structure mapped to the spatial Cartesian coordinate system of the porous medium are as follows:
$$\{ \begin{matrix}x = \frac{d}{2} * cos θ \\ y = \frac{d}{2} * sin θ \\ z = n * P + {p}_{0}\end{matrix}$$
$$wherein$$
$$n \sqrt{{( π D )}^{2} + {P}^{2}} \leq L - {l}_{1} \leq ( n + 1 ) \sqrt{{( π D )}^{2} + {P}^{2}}$$
$${p}_{0} = \frac{P}{L} * ( L - {l}_{1} - n \sqrt{{( π D )}^{2} + {P}^{2}} )$$
$$d = \frac{D}{L} * ( L - {l}_{1} - n \sqrt{{( π D )}^{2} + {P}^{2}} )$$
wherein (x, y, z) denote the coordinates of each temperature measurement point on the helical structure mapped to the spatial Cartesian coordinate system of the porous medium, θ denotes a helical angle, p₀ and d are intermediate variables, l₁ denotes an optical fiber length between a starting end of the sensing cage and a demodulator, l denotes a fiber winding length on the sensing cage, n denotes a serial number of a helical turn where a point is located on the helical structure, D denotes a diameter of the sensing cage, and P denotes a pitch.

18. The storage medium according to claim 15, wherein when at least two sensing cages are provided, the coordinates of each temperature measurement point on the helical structure mapped to the spatial Cartesian coordinate system of the porous medium are as follows:
$$\{ \begin{matrix}x = \frac{{d}^{′}}{2} * cos {θ}_{i} \\ y = \frac{{d}^{′}}{2} * sin {θ}_{i} \\ z = {n}_{i} * {P}_{i} + {p}_{0}^{′}\end{matrix}$$
$$wherein$$
$${p}_{0}^{′} = \frac{{P}_{i}}{{L}_{i}} * ( {L}_{i} - {\sum }_{i = 1}^{m} ( {l}_{i} + {L}_{i} ) - {n}_{i} \sqrt{{( π {D}_{i} )}^{2} + {P}_{i}^{2}} )$$
$${d}^{′} = \frac{{D}_{i}}{{L}_{i}} * ( {L}_{i} - {\sum }_{i = 1}^{m} ( {l}_{i} + {L}_{i} ) - {n}_{i} \sqrt{{( π {D}_{i} )}^{2} + {P}_{i}^{2}} )$$
wherein (x, y, z) denote the coordinates of each temperature measurement point on the helical structure mapped to the spatial Cartesian coordinate system of the porous medium, i denotes an ith sensing cage of the at least two sensing cages, l≤i≤m, m denotes a number of the at least two sensing cages, θᵢ denotes a helical angle of the helical structure on the ith sensing cage, p₀′ and d′ are intermediate variables, L; denotes an internal fiber winding length on the ith sensing cage, lᵢ denotes an optical fiber length between a starting end of the ith sensing cage and a demodulator, nᵢ denotes a serial number of a helical turn where a temperature measurement point is located on the helical structure of the ith sensing cage, Dᵢ denotes a diameter of the ith sensing cage, and Pᵢ denotes a pitch of the helical structure on the ith sensing cage.

19. The storage medium according to claim 15, wherein analyzing the change in the water content based on the initial moisture field and the post-infiltration moisture field and identifying the polyurethane diffusion distribution field in the porous medium in conjunction with the diffusion model comprises:
determining a water content reduction region based on the initial moisture field and the post-infiltration moisture field;
determining a region with reduced thermal conductivity in the porous medium based on a function relationship between a thermal conductivity and the water content according to the water content reduction region; and
identifying the polyurethane diffusion distribution field in the porous medium in conjunction with the diffusion model based on the region with reduced thermal conductivity in the porous medium.

20. The storage medium according to claim 19, wherein the diffusion model comprises a spherical diffusion model or a column-hemispherical diffusion model.
